(19) United States
(12) Patent Application Publication
(10) Pub. No.: US 2002/0085493 A1
(43) Pub. Date: Jul. 4, 2002

(54) Method and apparatus for over-advertising infiniband buffering resources

(76) Inventors: Rick Pekkala, Austin, TX (US); Christopher J. Pettey, Cedar Park, TX (US); Christopher L. Schreppel, Austin, TX (US)

Correspondence Address: JAMES W HUFFMAN, 1832 N. CASCADE AVE., COLORADO SPRINGS, CO, 80907-7449, US

(21) Appl. No.: 09/740,694

(22) Filed: Dec. 19, 2000

(51) Int. Cl. H04L 1/00

(52) U.S. Cl. 370/235; 370/252

(57) ABSTRACT

A method and system for over-advertising buffering resources for buffering packets coming into an Infiniband port. At least two IB data packets worth of flow control credits are advertised to the link partner for each virtual lane configured on the port so that the link partner may transmit packets at essentially full link bandwidth. The number of credits advertised may be greater than actual amount of buffering resources available to receive all the advertised packets. Once the actual amount of buffering resources available is less than a predetermined shutdown latency threshold, the port transmits zero credit flow control packets for each of the virtual lanes in order to shutdown the link partner from transmitting more packets. In one embodiment, an inline spill buffer is coupled between the port and shared buffers. The predetermined shutdown latency threshold is when all the shared buffers are in use. The inline spill buffer is sized to be capable of storing all the packets transmitted by the link partner during the shutdown latency. In another embodiment, no inline spill buffer is present, and the predetermined threshold is a reserved amount of the shared buffers large enough to store all the packets transmitted by the link partner during the shutdown latency.

### BACKGROUND OF THE INVENTION

1. Field of the Invention

This invention relates in general to packet buffering systems in Infiniband devices, and in particular to advertising flow control credits for buffering resources.

2. Description of the Related Art

The need for high bandwidth in transferring data between computers and their peripheral devices, such as storage devices and network interface devices, and between computers themselves is ever increasing. The growth of the Internet is one significant cause of this need for increased data transfer rates.

The need for increased reliability in these data transfers is also ever increasing. These needs have culminated in the development of the Infiniband™ Architecture (IBA), which is a high speed, highly reliable, serial computer interconnect technology. The IDA specifies interconnection speeds of 2.5 Gbps (Gigabits per second) (1×mode), 10 Gbps (4×mode) and 30 Gbps (12×mode) between IB-capable computers and I/O units.

One feature of the IBA that facilitates reliability and high speed data transfers within an Infiniband (IB) network is the virtual lane (VL) mechanism. Virtual lanes provide a means for IB devices such as channel adapters, switches, and routers within an IB network to transfer multiple logical flows of data over a single physical link. That is, on a single physical full-duplex link between two IB ports, the ports may negotiate to configure multiple VLs to transfer multiple logical data streams. Each packet transferred on the link specifies the VL in which the packet is directed.

The VL mechanism enables IB devices to provide differing qualities of service for different VLs. For example, packets in one VL, may be given higher priority than packets in other VLs. Or, packets on one VL may be transmitted with a particular service level, such as on a reliable connection service level, whereas packets in other VLs might have a connectionless level of service.

Another important performance and reliability feature of the IBA is link level flow control. The IDA requires an IB device to provide buffering resources for buffering incoming packets until the packets can be processed and disposed of. The link level flow control mechanism enables an TB port to ensure that it does not lose packets due to insufficient buffering resources. The IBA requires an IB device to provide at least the appearance of separate buffering resources for each data VL on an IB port.

The link level flow control mechanism enables a first port coupled by an IB link to a second port, referred to as a link partner, to advertise the amount of buffering resources available to the second port for buffering packets transmitted by it to the first port. That is, the first port advertises to the second port (the link partner) an amount of data that the link partner may transmit to the first port. Once the link partner transmits the advertised amount of data, the link partner may not transmit more data to the first port until authorized by the first port that it can do so. Link level flow control provides reliability for packet transmission on IB links by insuring that data packets are not lost due to a link partner overflowing the buffering resources of a receiving (or first) port.

IB link level flow control is performed on a per VL basis. The flow control mechanism transmits flow control packets between the first port and a link partner. Each flow control packet specifies a VL and an amount of flow control credits (or buffer resources available) for the specified VL. Since issuance of flow control credits are specific to VLs, a port may advertise a different number of flow control credits for different VLs on the same port.

One purpose of the IB link level flow control mechanism is to administer the bandwidth utilization of the link. In one instance, after a first port advertises flow control credits to a link partner, it may decline to advertise further flow control credits until its link partner utilizes the previously issued flow control credits. As the link partner begins transmitting data packets, the first port may issue additional flow control credits. However, if the link partner utilizes all of the advertised flow control credits before it receives any additional advertised credits (from the first port), it must cease transmitting data packets. In this situation, if the link partner has more data packets to transmit, it may not do so before receiving additional advertised flow control credits.

In addition, if an IB device cannot consume data as fast as the data is being transmitted to it, the device's buffering resources may become used up. In this instance, the device must employ link level flow control on one or more of its ports to avoid losing packets. For example, if many data packets are coming in on several ports of an IB switch and all are addressed to the same destination port on the switch, then the destination port may become a bottleneck. Since the incoming packets cannot be drained out of the destination port as fast as they are coming in from the other ports, the buffering resources within the switch may soon be used up. Thus, no more free buffers will be available to receive incoming packets. In this case, the incoming ports must employ link level flow control to stop their link partners from transmitting packets until additional buffers become free. This situation results in less than full utilization of the potential bandwidth on the links coupled to the incoming ports.

Current semiconductor manufacturing technology limits the amount of buffering resources, such as SRAM, that may be integrated into an Infiniband device. These buffering resources must therefore be allocated for use among the various virtual lanes on the various ports of the IB device. If the total number of virtual lanes on the device is relatively large, then the amount of buffering resources per virtual lane is limited. Thus, the flow control credits that are available to advertise to a link partner of an associated port may not be sufficient to sustain transfer rates at the link bandwidth. Therefore, the number of virtual lanes that the ports of the IB device may support may be reduced. This is undesirable since the benefits that virtual lanes provide may not be realized to their full extent.

Therefore, what is needed is a buffering scheme within an Infiniband device for supporting all 15 data virtual lanes allowed by the IBA while maintaining an acceptable level of performance in a realistic manufacturable manner.

### SUMMARY

To address the above-detailed deficiencies, it is an object of the present invention to provide a method and system of performing link level flow control to realize essentially full link bandwidth data transmission on all IBA-allowed data virtual lanes per port with a manufacturable amount of buffering resources on an IB device. Accordingly, in attainment of the aforementioned object, it is a feature of the present invention to provide a method for buffering packets transmitted to an Infiniband port by an Infiniband device linked to the port. The method includes providing a portion of a memory of size A for buffering the packets, and transmitting flow control credits to advertise to the device buffering resources of a size B, where B is greater than A. The method further includes determining the portion is filled a predetermined amount, and transmitting flow control credits to the device to stop transmission of the packets in response to the determining.

An advantage of the present invention is that it enables an IB port, or a plurality of IB ports, to support more data VLs than would otherwise be supportable while maintaining essentially full IB link bandwidth through over-advertising of buffering resources. In particular, the present invention enables support of all 15 data VLs as easily as eight, four or two data VLs with essentially the same amount of shared buffering resources.

Another advantage of the present invention is that it facilitates design of an IB channel adapter, switch or router that achieves a quality of service similar to a conventional IB channel adapter, switch or router but requires substantially less memory. Advantageously, the lesser memory requirement enables IB switches, routers and channel adapters to support a larger number of IB ports than would otherwise be achievable with current semiconductor process technologies.

Another advantage of the present invention is that by dynamically allocating shared packet buffers it achieves more efficient use of a given amount of packet memory than conventional approaches that statically allocate packet memory on a port/VL basis. This is because more of the packet memory can be dynamically allocated to port/VLs that experience greater amounts of data flow during a given time period than port/VLs experiencing smaller amounts of data flow.

In another aspect, it is a feature of the present invention to provide a method for controlling flow of packets into a plurality of ports on an Infiniband device. The method includes providing a memory of size A for buffering the packets, and transmitting flow control credits by the plurality of ports to advertise packet buffering resources of a size B. where B is greater than A. The method further includes transmitting flow control credits by at least one of the plurality of ports to stop transmission of the packets into the at least one port in response to determining an amount of free space in the memory drops below a predetermined threshold.

In yet another aspect, it is a feature of the present invention to provide a system for buffering packets transmitted by a link partner linked to an Infiniband port. The system includes a first memory, for buffering the packets from the port, flow control logic that advertises to the link partner more buffering resources than are available in the first memory for buffering the packets if space is available in the first memory to buffer the packets, and advertises no buffering resources if no space is available. The system also includes a second memory, coupled between the port and the first memory, for buffering the packets when no buffering resources are available in the first memory.

In yet another aspect, it is a feature of the present invention to provide a system for buffering packets transmitted by a link partner linked to an Infiniband port. The system includes a memory, having a size, an inline buffer, coupled between the port and the memory, for selectively buffering the packets if the memory is full, and flow control logic, that advertises to the link partner more flow control credits than space available in the memory. The flow control logic is also configured to advertise to the link partner zero flow control credits when the memory is full.

In yet another aspect, it is a feature of the present invention to provide a system for buffering packets transmitted by a link partner linked to an Infiniband port. The system includes a memory, for buffering the packets from the port, a buffer controller, for monitoring an amount of free space in the memory, and flow control logic that advertises to the link partner more buffering resources than are available in the memory for buffering the packets from the port if the buffer controller indicates the amount of free space is above a predetermined threshold.

In yet another aspect, it is a feature of the present invention to provide an Infiniband device. The Infiniband device includes a plurality of ports, each having a plurality of virtual lanes configured therein, and memory, for buffering packets received by the plurality of ports. The memory has a predetermined size. The device also includes flow control, for advertising an amount of buffering resources comprising at least two Infiniband packets worth of flow control credits for each of the plurality of virtual lanes configured in each of the plurality of ports. The advertised amount of buffering resources substantially exceeds the predetermined size of the memory.

In yet another aspect, it is a feature of the present invention to provide a buffering system in an Infiniband device. The buffering system includes a port, having a plurality of virtual lanes configured therein and a memory that buffers packets received by the port. The memory has a predetermined size. The system also includes flow control that advertises an amount of buffering resources comprising at least two Infiniband packets worth of flow control credits for each of the plurality of virtual lanes configured in the port. The advertised amount of buffering resources substantially exceeds the predetermined size of the memory.

### BRIEF DESCRIPTION OF THE DRAWINGS

These and other objects, features, and advantages of the present invention will become better understood with regard to the following description, and accompanying drawings where:

FIG. 1 is a block diagram of an Infiniband System Area Network according to the present invention.

FIG. 2 is a block diagram of a related art IB switch of FIG. 1.

FIG. 3 is a block diagram illustrating an IB data packet.

FIG. 4 is a block diagram illustrating a local routing header (LRH) from the data packet of FIG. 3.

FIG. 5 is a block diagram of an IB flow control packet.

FIG. 6 is a block diagram of an IB switch of FIG. 1 according to the present invention.

FIG. 7 is a block diagram of an IB packet buffering system according to the present invention.

FIG. 8 is a block diagram illustrating an input queue entry of the input queue of FIG. 7.

FIG. 9 is a block diagram illustrating an output queue entry of the output queue of FIG. 7.

FIG. 10 is a timing diagram for illustrating determination of a shutdown latency.

FIG. 11 is a flowchart illustrating initialization of the buffering system of FIG. 7.

FIG. 12 is a flowchart illustrating operation of the buffering system of FIG. 7 to perform over-advertising of buffering resources.

FIG. 13 is a block diagram illustrating free pool ranges within the shared buffers.

FIG. 14 is a flowchart illustrating further operation of the buffering system of FIG. 7.

FIG. 15 is a block diagram of an IB switch of FIG. 1 according to an alternate embodiment of the present invention.

FIG. 16 is a block diagram of an IB packet buffering system according to an alternate embodiment of the present invention.

FIG. 17 is a flowchart illustrating operation of the buffering system of FIG. 16 to perform over-advertising of buffering resources.

FIG. 18 is a block diagram illustrating a shutdown latency threshold.

### DETAILED DESCRIPTION

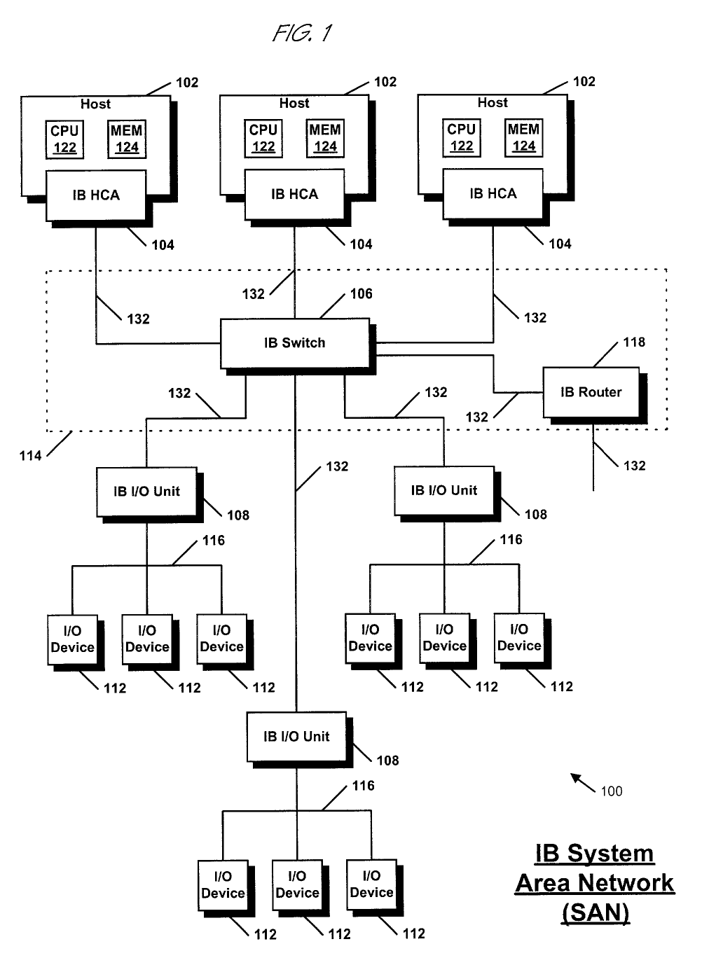

Referring to FIG. 1, a block diagram of an Infiniband (IB) System Area Network (SAN) 100 according to the present invention is shown. IB SANs such as SAN 100 are described in detail in the Infiniband Architecture Specification Volume 1 Release 1.0, Oct. 24, 2000, which is hereby incorporated by reference. The SAN 100 includes a plurality of hosts 102. The hosts 102 are IB processor end nodes, such as server computers, that comprise at least a CPU 122 and a memory 124. Each of the hosts 102 includes one or more IB Host Channel Adapters (HCA) 104 for interfacing the hosts 102 to an IB fabric 114. The IB fabric 114 is comprised of one or more IB Switches 106 and IB Routers 118 connected by a plurality of IB serial links 132. An IB serial link 132 comprises a full duplex transmission path between two IB devices in the IB fabric 114, such as IB switches 106, routers 118 or channel adapters 104. For example, an HCA 104 may be coupled to a host 102 via a PCI bus or the HCA 104 may be coupled directly to the memory and/or processor bus of the host 102.

The SAN 100 also includes a plurality of IB I/O units 108 coupled to the IB fabric 114. The IB hosts 102 and IB I/O units 108 are referred to collectively as IB end nodes. The IB end nodes are coupled by the IB switch 106 that connects the various IB links 132 in the IB fabric 114. The collection of end nodes shown comprises an IB subnet. The IB subnet may be coupled to other IB subnets (not shown) by the IB router 118 coupled to the IB switch 106.

Coupled to the I/O units 108 are a plurality of I/O devices 112, such as disk drives, network interface controllers, tape drives, CD-ROM drives, graphics devices, etc. The I/O units 108 may comprise various types of controllers, such as a RAID (Redundant Array of Inexpensive Disks) controller. The I/O devices 112 may be coupled to the I/O units 108 by any of various interfaces, including SCSI (Small Computer System Interface), Fibre-Channel, Ethernet, IEEE 1394, etc.

The I/O units 108 include IB Target Channel Adapters (TCAs) (not shown) for interfacing the I/O units 108 to the IB fabric 114. IB channel adapters, switches and routers are referred to collectively as IB devices. IB devices transmit and receive IB packets through the IB fabric 114. IB devices additionally buffer the IB packets as the packets traverse the IB fabric 114. The present invention includes a method and apparatus for improved buffering of IB packets in an IB device. The present invention advantageously enables IB devices to increase the amount of IB virtual lanes that may be configured on an IB port of an IB device. Additionally, the present invention potentially increases the number of IB ports that may be included in an IB device. Also, the present invention potentially reduces the amount of buffer memory required in an IB device.

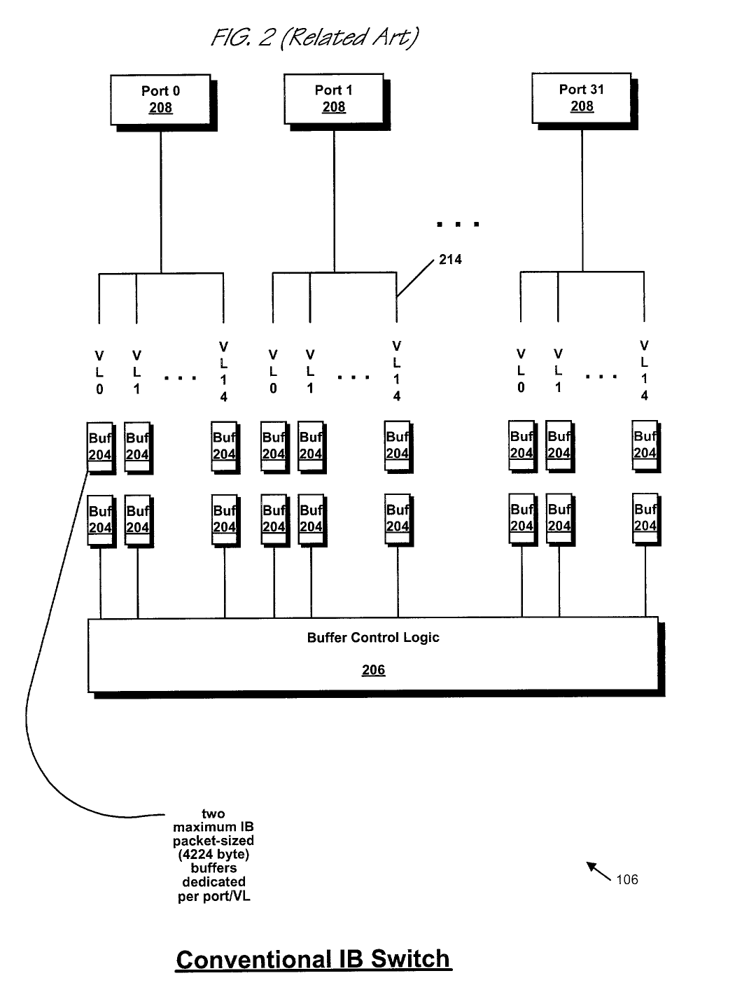

Referring now to FIG. 2, a block diagram of a related art IB switch 106 of FIG. 1 is shown. The benefits of the present invention will be more readily understood in light of a discussion of a conventional method of buffering IB packets, such as will now be provided with respect to the IB switch 106 of FIG. 2.

The IB switch 106 includes a plurality of IB ports 208. FIG. 2 illustrates an IB switch 106 with 32 ports. Each of the IB ports 208 links the IB switch 106 to another IB device, referred to as a link partner (not shown), by an IB serial link 132 of FIG. 1. The IB ports 208 transmit/receive IB packets to/from the link partner.

The IB switch 106 further includes a plurality of buffers 204 for buffering IB packets received from the IB ports 208. The IB switch 106 provides a plurality of buffers 204 for each of a plurality of IB data virtual lanes 214 supported for each port 208. Buffer control logic 206 controls the allocation of the buffers 204 and the routing of the packets in and out of the buffers 204 from and to the ports 208.

IB virtual lanes (VLs) provide a means to implement multiple logical flows of IB data packets over a single IB physical link 132. That is, VLs provide a way for two IB link partners to transfer independent data streams on the same physical link 132. Flow control of packets may be performed independently on each of the virtual lanes. Different virtual lanes may be used to achieve different levels of service for different data streams over the same physical IB link 132.

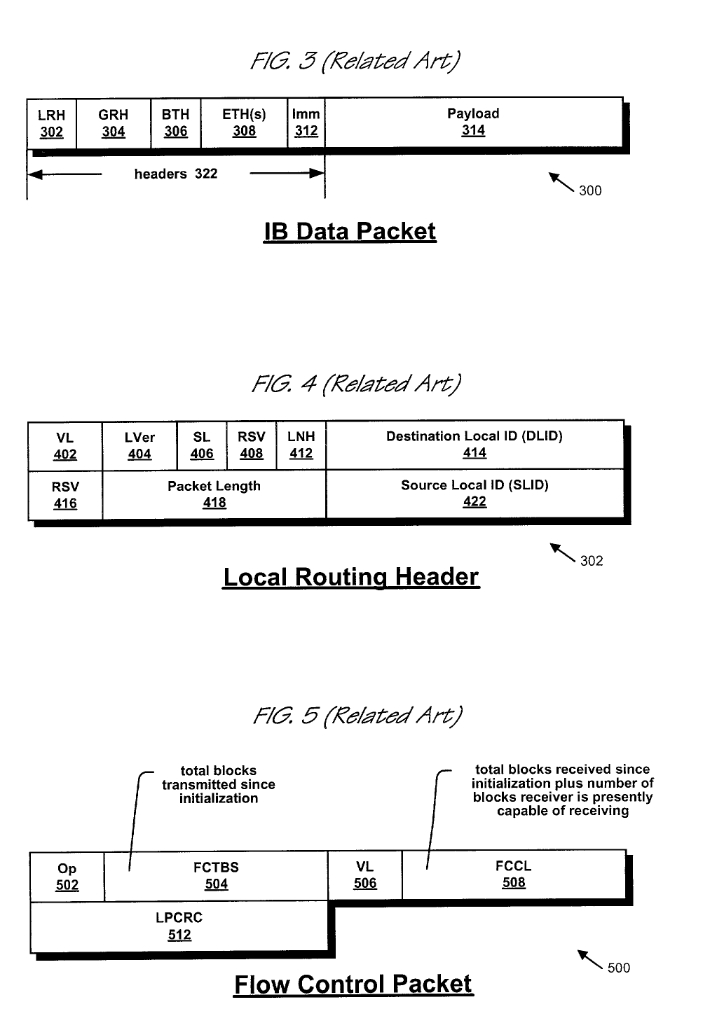

There are two types of VLs: management VLs and data VLs. VL15 is the management VL and is reserved for subnet management traffic. VLs 0 through 14 are data VLs and are used for normal data traffic. IB ports 208 are required to support VL0 and VL15. Support of VL1-14 is optional. VL15 is not subject to flow control. The first four bits of each IB data packet specify the VL of the packet, as described below with respect to FIGS. 3 and 4. A data VL is “supported” if an IB port is capable of transmitting and receiving IB data packets for the specified VL. A data VL is “configured” if it is a supported VL and is currently operational.

Referring to FIG. 3, a block diagram illustrating an IB data packet 300 is shown. The data packet 300 includes a data payload 314 and one or more header fields 322. The maximum size of the payload 314 is a function of the maximum transfer unit (MTU) of the path between the IB device sourcing the packet 300 and the IB device sinking the packet 300. The maximum IBA-defined MTU, and thus the maximum size of the payload 314, is 4096 bytes. The MTU for a path between the source and destination devices is limited to the smallest MTU supported by a given link 132 in the path between the devices. In many network applications, particularly ones with large transfer sizes, it is more efficient to support the maximum MTU of 4096 bytes, since the smaller the MTU, the greater number of packets the data transfer must be broken up into, and each packet 300 incurs an associated overhead due to the packet headers 322.

The header fields include a mandatory local routing header (LRH) 302 used by a link layer in a communication stack for routing the packet 300 within an IB subnet. The remainder of the headers 322 may or may not be present depending upon the type of packet 300. The optional headers 322 include a global routing header (GRH) 304 used by a network layer in a communication stack for routing packets 300 between IB subnets. The headers 322 also include a base transport header (BTH) 306 and one or more extended transport headers (ETH) 308 used by a transport layer in a communication stack. Finally, an immediate data field (Imm) 312 is optionally included in the packet 300. Considering all possibilities of optional headers, an IB data packet 300 can be no larger than 4224 bytes.

Referring to FIG. 4, a block diagram illustrating a local routing header (LRH) 302 from the packet 300 of FIG. 3 is shown. The LRH 302 includes a virtual lane (VL) field 402. The VL field 402 specifies the virtual lane to which the packet 300 is directed. A port 208 populates the VL field 402 with the appropriate VL prior to transmitting the packet 300. Conversely, a port 208 decodes the VL field 402 upon reception of a packet 300 to determine the VL to which the packet 300 is directed. The VL field 402 may have any value between 0 and 15 inclusive. If the VL 402 specified in the packet 300 received by the input port of an IB switch or router is not configured on the switch or router output port link, then the switch or router must modify the VL 402 to a configured VL value before re-transmitting the packet 300.

The LRH 302 includes a LVer field 404 specifying the IB link level protocol version, a service level (SL) field 406 specifying a service class within the subnet, reserved (RSV) fields 408 and 416, and a link next header (LNH) field 412 for indicating that other headers follow the LRH 302. The LRH 302 also includes a Destination Local ID (DLID) field 414 for identifying within the subnet the IB port destined to sink the packet 300. The LRH 302 also includes a Source Local ID (SLID) field 422 for identifying within the subnet the IB port originating the packet 300. IB switches use the DLID 414 and SLID 422 fields to route packets within an IB subnet. Finally, the LRH 302 includes a packet length field 418 for specifying the length in bytes of the packet 300.

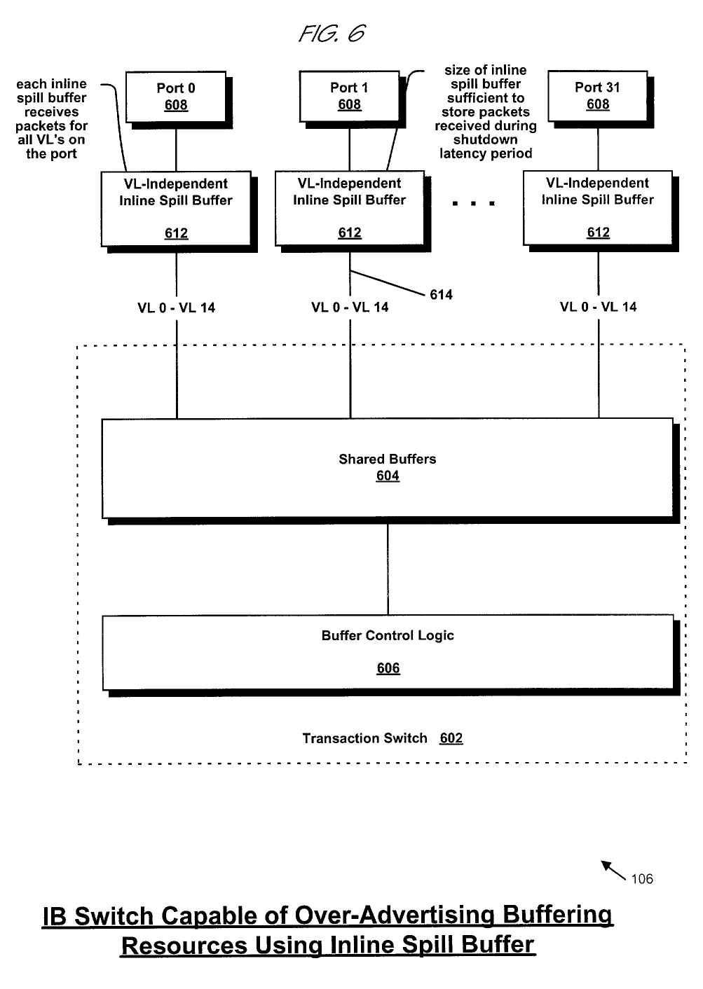

Referring to FIG. 5, a block diagram of an IS flow control packet 500 is shown. IB ports, such as port 208, coupled by an IB link 132, exchange flow control packets 500 in order to achieve link level flow control. The link level flow control prevents packet 300 loss due to buffer overflow at a receiving port. A port 208 sends a flow control packet 500 to its link partner to advertise to the link partner the amount of buffer space that it has available in the port 208 for receiving data.

The flow control packet 500 includes an operation field (Op) 502 for specifying whether the packet 500 is a normal or initialization packet and a link packet cyclic redundancy check (LPCRC) field 512 for error detection. The packet 500 also includes a virtual lane (VL) field 506 for specifying the VL on which the flow of data packet 300 is being controlled.

The packet 500 also includes a flow control total block sent (FCTDO) field 504 and a flow control credit limit (FCCL) field 508. The FCTBS 504 and the FCCL 508 are used to advertise the amount of buffer space available to receive data packets 300 in the port 208 transmitting the flow control packet 500. The FCTBS 504 indicates the total number of IB blocks transmitted by the port 208 in the specified VL 506 since initialization time. The number of IB blocks comprising an IB data packet 300 is defined by the IBA as the size of the packet 300 in bytes divided by 64 and rounded up to the nearest integer. That is, an IB block for flow control purposes is 64 bytes. The FCCL 508 indicates the total number of IB blocks received by the port 208 in the specified VL 506 since initialization plus the number of IB blocks the port 208 is presently capable of receiving.

Thus upon receiving a flow control packet 500 from its link partner, a port 208 may determine the amount of IB blocks worth of data packets 300 the port 208 is authorized to transmit in the specified VL 506. That is, the port 208 may determine from the flow control packet 500 the amount of IB blocks worth of buffer space advertised by the link partner for the specified VL 506 according to the IBA specification incorporated by reference above.

Advertising zero IB blocks worth of credits, i.e., zero credits, instructs the link partner to stop transmitting data packets 300 in the specified VL 506. Advertising 66 IB blocks worth of credits, for example, authorizes the link partner to transmit one maximum-sized IB data packet 300 in the specified VL 506, i.e., 66 blocks*64 bytes/block=4224 bytes.

In the present disclosure, it is simpler to discuss flow control credits, or credits, in terms of IB data packets 300 worth of credits, rather than IB blocks (i.e., 64-byte quantities, discussed above) worth of credits. Hence, for clarity of discussion, this specification will use the term “credit” or “flow control credit” to refer to a maximum-sized IB data packet 300 worth of credits rather than an IB flow control block worth of credits, unless specified otherwise. For example, the term “2 credits” will refer to 8448 bytes worth of flow control credits, or 132 IB blocks worth of credits, as specified in the FCCL 508, in the case where the MTU is the maximum 4096 bytes.

Referring again to FIG. 2, the IB switch 106 includes two buffers 204 associated with each of the virtual lanes 214 in each of the ports 208. One of the main features of the IB Architecture is its high data transfer rate on the serial link 132. It is desirable, therefore, to perform packet buffering and flow control on the link 132 in such a manner as to fully utilize the data transfer bandwidth. Given the IB flow control mechanism described above with respect to FIG. 5, in order to fully utilize the link 132 bandwidth, a port 208 should attempt to advertise at least 2 credits (i.e., 2 IB data packets 300 worth of flow control credits) to its link partner at all times.

Understanding why a port 208 should advertise at least 2 credits of buffering resources in order to sustain close to full bandwidth utilization may best be understood by examining a situation in which the port 208 advertises only 1 credit. Assume the port 208 advertises to the link partner 1 credit. The link partner transfers a packet 300. The port 208 receives the packet 300. The port 208 determines that it should transmit a flow control packet 500 to the link partner to advertise another credit. However, just prior to determining the need to transmit a flow control packet 500, the port 208 began to transmit a data packet 300. The port 208 must wait to transmit the flow control packet 500 until the data packet 300 has been transmitted. While the port 208 is transmitting the data packet 300, the link partner is sitting idle not transmitting data packets 300 because it has not been authorized to transmit more than one data packet 300. Thus, when the port 208 consistently advertises only 1 credit, the full bandwidth of the link 132 is not utilized.

In contrast, advertising at least 2 credits enables the link partner to transmit a first packet 300 and then begin to transmit a second packet 300 immediately after the first packet 300 without having to wait for another flow control packet 500. Since the port 208 has advertised 2 credits, it is no longer catastrophic to link 132 performance if the port 208 had just begun transferring a data packet 300 when it determined the need to transmit a flow control packet 500. Rather, the port 208 can transmit a flow control packet 500 to the link partner when the port 208 finishes transmitting the packet 300, and the link partner will receive the flow control packet 500 well before the link partner goes idle.

Furthermore, the port 208 must advertise 2 credits for not only one VL, but for each configured VL 214, in order to insure full link 132 bandwidth utilization. This would not necessarily be true if it were guaranteed that the link partner had packets 300 to transmit for all the virtual lanes 214. Consider the case of the port 208 advertising only 1 credit per VL 214. If the link partner went idle for lack of credits on one of the VLs 214, then the link partner could be transmitting a packet 300 in a different VL 214 while waiting for a flow control packet 500 for the idle VL 214. However, the link partner may only have packets 300 to transmit for one VL 214 during a given period. Thus, because the port 208 cannot be guaranteed that the link partner has packets 300 to transmit for more than one VL 214, the port 208 should advertise at least 2 credits for each VL 214 in order to avoid idle time on the link 132 resulting in sub-optimal link 132 bandwidth utilization.

A conventional IB switch, such as switch 106 of FIG. 2, advertises only as many buffering resources as it actually has available to receive packets 300. Therefore, switch 106 includes 2 packets 300 worth of buffering resources 204 per VL 214 per port 208, in order to be able to advertise 2 credits per VL 214 per port 208.

Illustratively, the IB switch 106 of FIG. 2 supports all 15 IB data VLs 214 and 32 ports 208. According to the following calculations, the switch 106 requires approximately 4 MB worth of buffering resources 204.

32 ports*15 VL/port,*8448 bytes/VL=4,055,040 bytes

Due to the speed requirements in IB devices, the buffers 204 are typically implemented as static random access memory (SRAM). Furthermore, the SRAM must typically be dual-ported SRAM, since data is being written into a buffer 204 by one port 208 and simultaneously read out from the buffer 204 by another port 208 for transmission on another link 132 to another link partner in the fabric 114. Presently, the largest dual-ported SRAMs on the market are capable of storing on the order of 1 MB of data.

Importantly, the 1 MB SRAM chips on the market today consume all the available chip real estate with SRAM cells, thereby leaving no real estate for other logic, such as the port logic 208 or buffer control logic 206 necessary in an IB switch 106. Clearly, current semiconductor manufacturing technology limits the number of VLs that may be supported on an IB switch 106. Alternatively, if all the data VLs are to be supported, then the number of ports 208 and/or buffers 204 and/or MTU size on the switch 106 must disadvantageously be reduced.

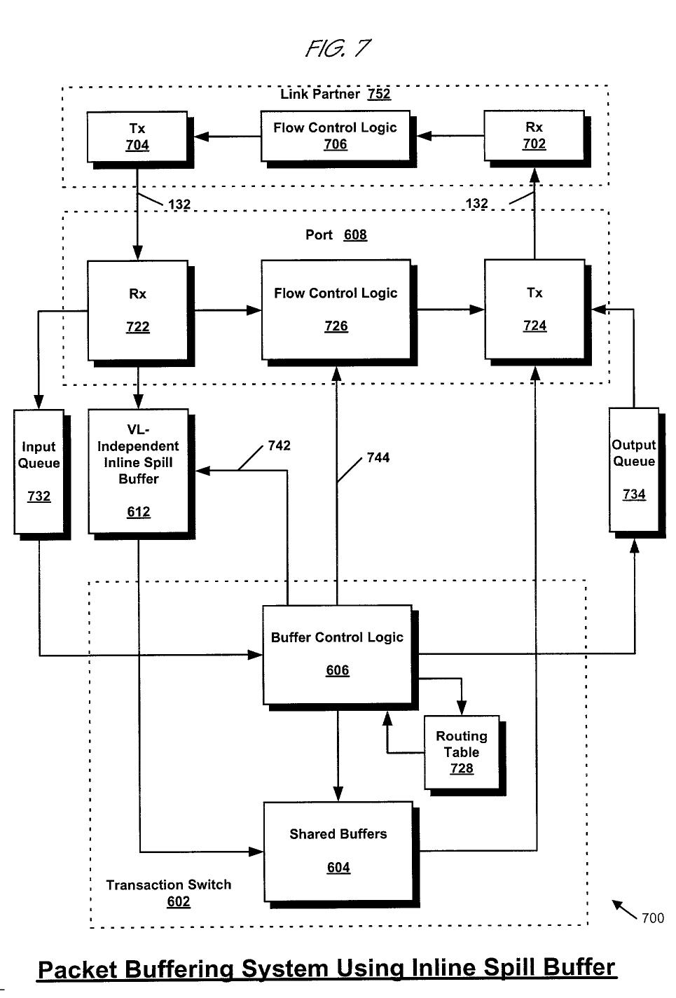

Referring now to FIG. 6, a block diagram of an IB switch 106 of FIG. 1 according to the present invention is shown. The present invention is readily adaptable to all IB devices, such as IB routers and IB channel adapters, and is not limited to IB switches. Hence, FIG. 6 shows an IB switch 106 for illustrating the present invention in an IB device generally.

The present inventors advantageously have observed that although an IB port may support multiple virtual lanes, the port can only transmit one packet at a time on its physical link. Since each packet specifies a particular virtual lane, the port can only transmit in one virtual lane at a time.

Consequently, the present inventors have advantageously observed that the amount of port buffering resources that are necessary need only be large enough to receive as many packets as the link partner can transmit, until the port can stop the link partner from transmitting any more packets. This is independent of the particular virtual lanes specified in the transmitted packets.

Consequently, the present inventors have advantageously observed that an IB port may advertise a number of credits for all the VLs configured for a port, the sum of the credits advertised being greater than the actual amount of buffer resources available to the port to receive the advertised credits, a method referred to herein as over-advertising buffering resources, or over-advertising. In particular, the present inventors have advantageously observed that an IB port may advertise at least two data packets worth of credits for all the VLs configured for a port in order to utilize essentially full link bandwidth, even though the sum of the two credits per VL is greater than the actual amount of buffer resources available to receive the advertised credits. Over-advertising is possible because the IB port can transmit flow control packets to completely stop the link partner from transmitting data packets in much less time than the link partner can transmit the over-advertised amount of packet data. That is, the port can shut down the link partner well before the link partner can consume the over-advertised credits, thereby avoiding packet loss due to buffer overrun. The port shuts down the link partner by advertising zero credits for each VL to the link partner, as will be described below in detail.

The switch 106 comprises a plurality of IB ports 608. For example, the switch 106 of FIG. 6 comprises 32 IB ports 608. Each of the ports 608 is coupled to a corresponding one of a plurality of virtual lane-independent inline spill buffers 612. The inline spill buffers 612 are coupled to a transaction switch 602. The transaction switch 602 comprises shared buffers 604 and buffer control logic 606.

The ports 608 and inline spill buffers 612 are capable of supporting a plurality of VLs 614, namely VLs 0 through 14. Each of the inline spill buffers 612 receives IB data packets 300 specifying any of the VLs 614 configured on its corresponding port 608. Advantageously, the size of an inline spill buffer 612 is sufficient to store packets 300 received during a latency period required to shut down the corresponding link partner from transmitting more packets 300 in response to the transaction switch 602 determining that no more shared buffers 604 are available to buffer packets 300 from the port 608.

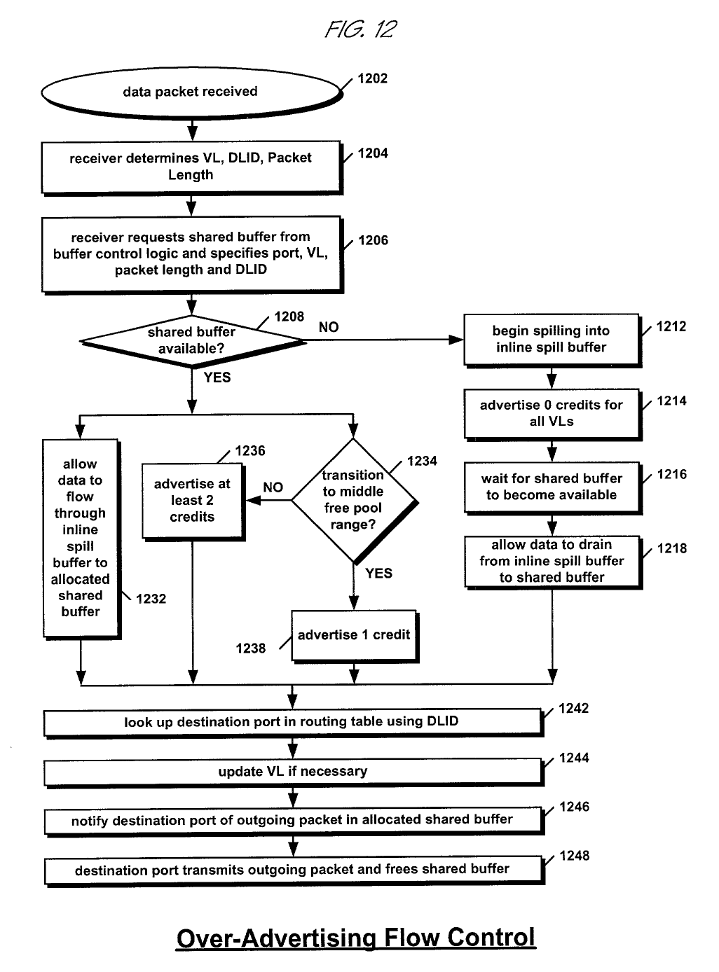

Preferably, the inline spill buffers 612 comprise first-in-first-out memories. An inline spill buffer 612 receives packet 300 data from its corresponding port 608, independent of the VL 614 specified, and selectively provides the data to an available shared buffer 604 or stores the data until a shared buffer 604 becomes available to store the data. Advantageously, the inline spill buffers 612 enable the ports 608 to advertise more flow control credits worth of buffering resources across the VLs 614 than is available in the shared buffers 604 to receive the packets 300. In particular, the inline spill buffers 612 enable the ports 608 to advertise at least two packets 300 worth of flow control credits for all the configured VLs 614, thereby enabling utilization of substantially all the link 132 bandwidth. In one embodiment, the inline spill buffers 612 comprise approximately 10 KB of FIFO memory, as described in more detail with respect to FIG. 10.

Preferably, the shared buffers 604 comprise a plurality of dual-ported SRAM functional blocks. In one embodiment, the shared buffers 604 comprise 32 dual-ported SRAM blocks. Each SRAM block is accessible by each of the ports 608. Thus, the shared buffers appear as a large 128-port SRAM. Thereby, as long as a buffer 604 is available in one of the individual SRAMs, it may be allocated to an IB port 608 needing a buffer, and the IB port 608 need not wait for an SRAM port to become available. Preferably, the transaction switch 602 is capable of simultaneously supporting a 32-bit read and write from each of the ports 608.

Advantageously, the present invention enables the size of the shared buffers 604 to be an amount that may be realistically manufactured by contemporary semiconductor technologies at a reasonable cost, as will be seen from the description below. In one embodiment, the shared buffers 604 comprise approximately 256 KB of SRAM buffering resources. However, the present invention is not limited by the amount of shared buffers 604. Rather, the present invention is adaptable to any amount of shared buffers 604. That is, over-advertising more buffer resources than are available in the shared buffers 604 is not limited by the size of the shared buffers 604. In particular, as semiconductor manufacturing technology progresses enabling larger amounts of shared buffers 604 to be manufactured, the present invention is adaptable and scalable to be utilized in IB devices employing the larger amounts of shared buffers 604. Preferably, the shared buffers 604 are organized in “chunks” of memory, such as 64 or 128 byte chunks, which are separately allocable by the buffer control logic 606.

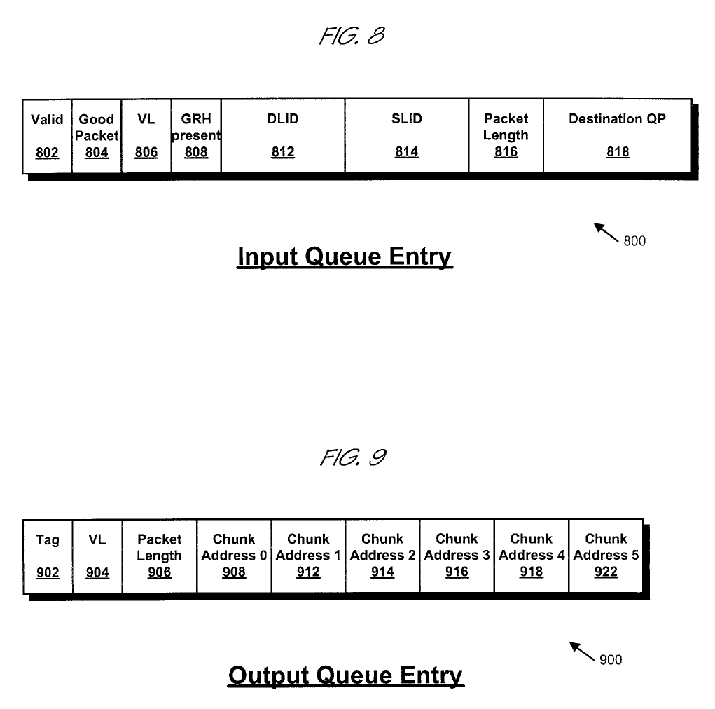

Buffer control logic 606 controls the allocation of the shared buffers 604 and the routing of the packets 300 into and out of the buffers 604 from and to the ports 608 as described in detail below. In one embodiment, the shared buffers 604 are allocated by the buffer control logic 606 such that the buffers 604 are shared between all the ports 608 and VLs 614 in common. In another embodiment, the buffers 604 are logically divided among the ports 608 and are shared within a port 608 between all the VLs 614 of the port 608. In another embodiment, the allocation of the buffers 604 among the ports 608 and VLs 614 is user-configurable. The ports 608, inline spill buffers 612 and transaction switch 602 are described in more detail with respect to FIGS. 7 through 14.

Referring now to FIG. 7, a block diagram of an IB packet buffering system 700 according to the present invention is shown. The buffering system 700 comprises an ID port 608 of FIG. 6, a transaction switch 602 of FIG. 6, an inline spill buffer 612 of FIG. 6, an input queue 732 and an output queue 734. Preferably, the transaction switch 602 is shared among all ports in the switch 106 of FIG. 6. In contrast, preferably one inline spill buffer 612, input queue 732 and output queue 734 exist for each port 608 of the switch 106.

The buffering system 700 comprises an ID port 608 coupling the switch 106 to an ID link 132. The other end of the IB link 132 is coupled to an IB link partner 752, such as an ID HCA 104 or Router 118 of FIG. 1.

The port 608 comprises an IB. transmitter 724 that transmits IB packets, such as data packets 300 and flow control packets 500, across one half of the full-duplex ID link 132 to a receiver 702 in the link partner 752. The port 608 further includes an ID receiver 722 that receives ID packets across the other half of the full-duplex ID link 132 from a transmitter 704 in the link partner 752. The port 608 also includes flow control logic 726 coupled to the receiver 722 and transmitter 724. The flow control logic 726 receives flow control packets 500 from the receiver 722 and provides flow control packets 500 to the transmitter 724 in response to control signals 744 from the buffer control logic 606 of FIG. 6 comprised in the transaction switch 602 of FIG. 6.

The link partner 752 also includes flow control logic 706 coupled to the receiver 702 and transmitter 704. The link partner 752 flow control logic 706 receives flow control packets 500 from the link partner 752 receiver 702 and provides flow control packets 500 to the link partner 752 transmitter 704. Among other things, the link partner 752 flow control logic 706 responds to flow control packets 500 received from the port 608 advertising zero credits, and responsively stops the link partner 752 transmitter 704 from transmitting IB data packets 300 to the port 608. It is noted that IB port transmitters, such as the link partner 752 transmitter 704, may only transmit entire packets 300. Thus, even if the link partner 752 has one flow control block (i.e., 64 bytes) of flow control credit, it cannot transmit a portion of a packet 300 waiting to be transmitted. Instead, the link partner 752 must wait until it has enough flow control credits to transmit an entire packet. Similarly, once a transmitter, such as link partner 752 transmitter 704 or transmitter 724, begins to transmit a packet 300, it must transmit the entire packet 300. Thus, even if a flow control packet 500 is received by the link partner 752 advertising zero credits, if the link partner 752 is in the process of transmitting a packet 300, it does not stop transmitting the packet 300 part way through.

The inline spill buffer 612 of FIG. 6 is coupled to the output of the receiver 722 for receiving packet 300 data from the receiver 722. The inline spill buffer 612 output is coupled to the shared buffers 604 of FIG. 6 for providing packet 300 data to the shared buffers 604 comprised in the transaction switch 602. The buffer control logic 606 controls the selective storage of packet 300 data in the inline spill buffer 612 via a control signal 742. When the buffer control logic 606 determines that a shared buffer 604 is not available to store a packet 300 received by the receiver 722, the buffer control logic 606 asserts the control signal 742 to cause the inline spill buffer 612 to store the packet 300 data rather than passing the data through to the shared buffers 604.

The buffering system 700 further includes an input queue 732 coupled between the receiver 722 and the buffer control logic 606 and an output queue 734 coupled between the buffer control logic 606 and the transmitter 724. The input queue 732 and output queue 734, referred to also as transaction queues, are preferably FIFO memories for receiving and transmitting commands, addresses and other information between the port 608 and the Transaction Switch 602.

When the receiver 722 receives the LRH 302 of FIG. 3 of a packet 300, the receiver 722 decodes the packet 300 and places an entry in the input queue 732 to instruct the transaction switch 602 to process the packet 300. The transaction switch 602 monitors the input queue 732 for commands from the receiver 722. Conversely, the transaction switch 602 submits an entry to the transmitter 724 via the output queue 734 when the transaction switch 602 desires the transmitter 724 to transmit a packet 300 from a shared buffer 604.

Referring now to FIG. 8, a block diagram illustrating an input queue entry 800 of the input queue 732 of FIG. 7 is shown. The input queue entry 800 includes a valid bit 802 for indicating the entry 800 contains a valid command. A good packet bit 804 indicates whether the packet 300 corresponding to the entry 800 has any bit errors. A VL field 806 is a copy of the VL field 402 of the LRH 302 of FIG. 4 from the packet 300 corresponding to the entry 800. A GRH present bit 808 indicates that a GRH 304 of FIG. 3 is present in the packet 300 corresponding to the entry 800. DLID 812, SLID 814 and Packet Length 816 fields are copied from the DLID 414, SLID 422 and Packet Length 418 fields, respectively, of the packet 300 LRH 302 corresponding to the entry 800. Finally, the entry 800 comprises a Destination QP (Queue Pair) field 818 copied from the BTH 306 of FIG. 3. The Destination QP field 818 is particularly useful when employing the buffering system 700 of FIG. 7 in an IB channel adapter.

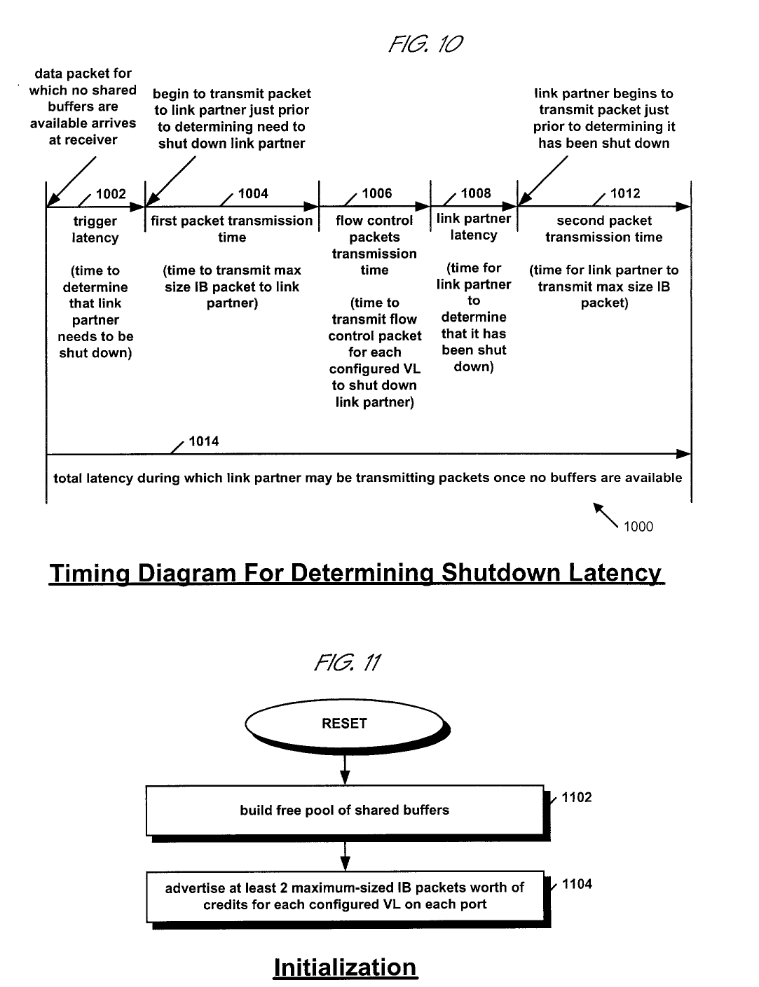

Referring now to FIG. 9, a block diagram illustrating an output queue entry 900 of the output queue 734 of FIG. 7 is shown. The output queue entry 900 includes a tag 902 used to determine when an output transaction has fully completed. A VL field 904 specifies the VL in which the transmitter 724 is to transmit the packet 300 corresponding to the entry 900. A Packet Length field 906 specifies the length in bytes of the packet 300 corresponding to the entry 900. The entry 900 also includes a plurality of chunk address fields 908-922 for specifying an address of a chunk of buffer space within the shared buffers 604 in which the packet 300 corresponding to the entry 900 is located. That is, as described above, the packet 300 may be fragmented into multiple chunks within the shared memory 604. The transmitter 724 uses the chunk addresses 908-922 to fetch the data from the shared buffer 604 chunks and construct the packet 300 for transmission to the link partner 752. In one embodiment, the number of chunk address fields is 5. However, the output queue entry 900 is not limited to a particular number of chunk address fields.

Referring again to FIG. 7, the Transaction Switch 602 includes a routing table 728. The routing table 728 includes a list of local subnet Ids and corresponding port number identifying the ports 608 of the switch 106. When the buffer control logic 606 receives an input queue entry 800 generated by the receiver 722 upon reception of a packet 300, the buffer control logic 606 provides the DLID 812 to the routing table 728. The routing table 728 returns a value specifying to which of the ports 608 of the switch 106 the destination IB device is linked. The buffer control logic 606 uses the returned port value to subsequently generate an output queue entry 900 for submission to the appropriate output queue 734 of the switch 106 for routing of the packet 300 to the appropriate port 608.

Referring now to FIG. 10, a timing diagram 1000 for illustrating determination of a shutdown latency 1014 is shown. The timing diagram 1000 is used to determine the minimum size of the inline spill buffers 612 of FIG. 6. In addition, the timing diagram 1000 is used to determine the shutdown latency threshold 1816 described below with respect to FIG. 18. Presently, FIG. 10 will be described with reference to determination of the inline spill buffer 612 size.

The shutdown latency 1014 shown is an amount of time during which the link partner 752 of FIG. 7 may be transmitting packets once no shared buffers 604 of FIG. 6 are available to buffer a data packet 300 of FIG. 3 arriving at the receiver 722 of FIG. 7. That is, the shutdown latency is the time required for the flow control logic 726 of FIG. 7 to shut down the link partner 752 in response to notification from the buffer control logic 606 that no buffers 604 are available to receive the packet 300.

The shutdown latency 1014 comprises five components: a trigger latency 1002, a first packet transmission time 1004, a flow control packets transmission time 1006, a link partner latency 1008, and a second packet transmission time 1012. The shutdown latency is approximately the sum of the five components.

The trigger latency 1002 begins when a data packet 300 for which no shared buffer 604 is available arrives at the receiver 722. When the receiver 722 receives the packet 300, the receiver 722 submits an input queue entry 800 to the input queue 732 requesting a buffer 604. The buffer control logic 606 monitors the input queue 732 and detects the input queue entry 800. The buffer control logic 606 attempts to allocate a buffer 604 for the packet 300 and determines no buffer 604 is available. The buffer control logic 606 notifies the flow control logic 726 via signal 744 to shutdown the link partner 752. The flow control logic 726 instructs the transmitter 724 to transmit zero credit flow control packets 500. However, the transmitter 724 is already transmitting a data packet 300. The trigger latency 1002 ends when the flow control logic 726 of FIG. 7 determines that it cannot transmit flow control packets to shut down the link partner 752 because the transmitter 724 is currently transmitting a data packet 300 to the link partner 752. That is, the trigger latency 1002 comprises the time to determine that the link partner 752 needs to be shut down and that the transmitter 724 is busy. In the worst case, the transmitter 724 begins to transmit the packet 300 to the link partner 752 just prior to being instructed by the flow control logic 726 to transmit the flow control packets 500. The number of bytes that may be transmitted on a 12x (i.e., 30 Gbps) IB link 132 during the trigger latency 1002 is estimated to be approximately 100 bytes.

The first packet transmission time 1004 is the amount of time required for the transmitter 724 to transmit the maximum-sized IB packet 300 to the link partner 752. The maximum size IB packet that the transmitter 724 may transmit to the link partner 752 is a function of the MTU size between the transmitter 724 and the link partner 752. If the MTU is the IBA maximum size MTU, i.e., 4096, then the maximum IB packet size is 4224 bytes, i.e., the maximum payload size of 4096 plus the largest possible header size of 128. Hence, the transmitter 724 must transmit 4224 bytes. However, if the MTU is 256, for example, then the maximum IB packet size the transmitter 724 may transmit to the link partner 752 is 384 bytes (256 payload+128 header).

The flow control packets transmission time 1006 is the amount of time required for the transmitter 724 to transmit to the link partner 752 a flow control packet 500 for each VL 614 configured on the port 608. The flow control packets 500 advertise zero credits in order to shut down the link partner 752 from transmitting data packets 300. Assuming 15 data VLs are configured, the transmitter 724 must transmit:

6 bytes/packet*15 packets=90 bytes.

The link partner latency 1008 begins when the link partner 752 receives the flow control packets 500 transmitted by the port 608 during the flow control packets transmission time 1006. The link partner latency 1008 ends when the link partner 752 flow control logic 706 attempts to stop transmission of packets for all configured VLs 614. In the worst case, the link partner 752 transmitter 704 begins to transmit the packet 300 just prior to being instructed by the link partner 752 flow control logic 706 to stop transmitting packets 300. Thus, the link partner latency 1008 comprises the time for the link partner 752 to determine it has been shut down by the port 608. The number of bytes that may be transmitted on a 12x IB link 132 during the link partner latency 1008 is estimated to be approximately 100 bytes.

The second packet transmission time 1012 is the amount of time required for the link partner 752 to transmit the maximum-sized IB packet 300 to the receiver 722. As described above with respect to the first packet transmission time 1004, if the MTU size is 4096, for example, the link partner 752 transmitter 704 must transmit 4224 bytes. If the MTU size of 256, the link partner 752 transmitter 704 must transmit 384 bytes.

Thus, it may be observed from the foregoing discussion that for an IB device to support, for example, an MTU size of 4096, the size of the inline spill buffer 612 must be at least:

(4224*2)+90+(100 * 2)=8798 bytes.

Preferably, the inline spill buffer 612 is 10 KB. Because the trigger latency 1002 and link partner latency 1008 may vary, in another embodiment, the inline spill buffer 612 is 12 KB. In another embodiment, the inline spill buffer 612 is 16 KB.

For an IB device to support an MTU size of 256, the smallest IBA supported MTU, the size of the inline spill buffer 612 must be at least:

(256*2)+90 +(100*2)=802 bytes.

Thus, in another embodiment, the inline spill buffer 612 is 1 KB. Because the trigger latency 1002 and link partner latency 1008 may vary, in another embodiment, the inline spill buffer 612 is 3 KB. In another embodiment, the inline spill buffer 612 is 5 KB.

Since the MTU sizes supported by IBA are 256, 512, 1024, 2048 and 4096, other embodiments are contemplated wherein the inline spill buffer 612 size ranges between 1 KB and 16 KB.

Referring now to FIG. 11, a flowchart illustrating initialization of the buffering system 700 of FIG. 7 is shown. After reset, the transaction switch 602 of FIG. 6 builds a pool of free shared buffers 604 of FIG. 6, in step 1102. The free pool is created in anticipation of future allocation of the shared buffers 604 for reception of incoming IB data packets 300. In one embodiment, step 1102 comprises creating a plurality of free pools if the buffers 604 are not shared among all the ports 608 and VLs 614 of FIG. 6, but instead are shared on a per port 608 basis or are user-configured.

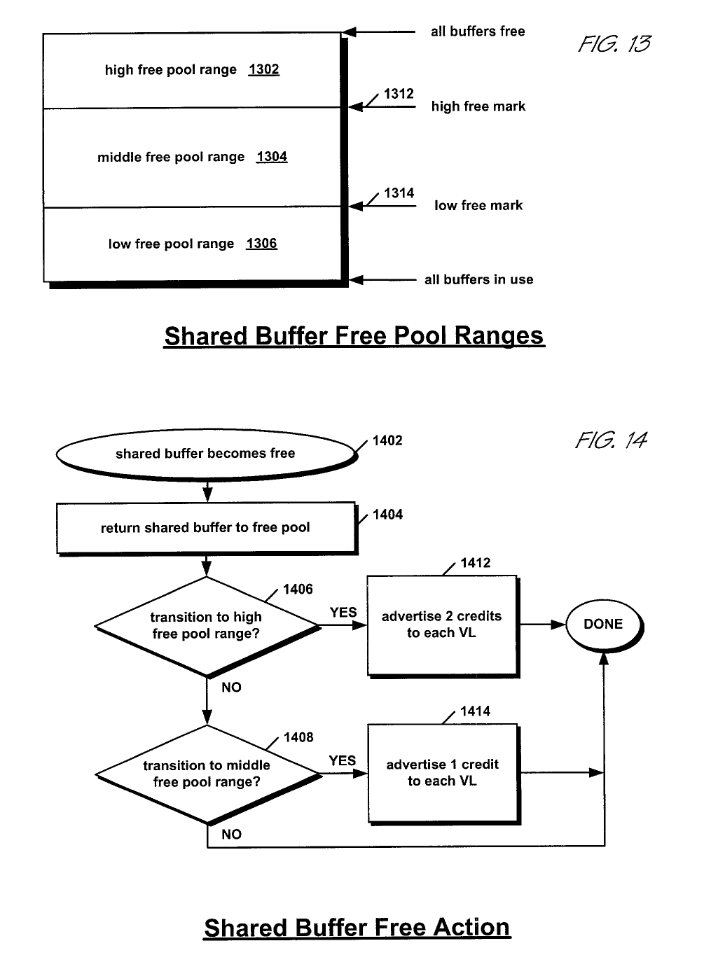

After the free pools are built, the links 132 are initialized and the VLs 614 are configured, the buffering system 700 advertises at least 2 credits of buffering resources for each VL 614 on each of the ports 608, in step 1104. In the example switch 106 of FIG. 6, advertising 2 credits for each of 15 VLs 614 on each of the 32 ports 608 comprises advertising approximately 4 MB of buffering resources, thereby over-advertising the amount of buffering resources 604 available. As packets 300 are transmitted to the switch 106 ports 608, the shared buffers 604 are dynamically allocated for use and subsequently de-allocated and returned to the free pool during operation of the switch 106. As described above, by advertising at least 2 credits for each port/VL combination, the buffering system 700 advantageously enables usage of substantially the entire data transfer bandwidth on the links 132 if the link partners are capable of supplying the data to satisfy the bandwidth. Over-advertising of the port 608 buffering resources during operation of the switch 106 will now be described with respect to FIG. 12.

Referring now to FIG. 12, a flowchart illustrating operation of the buffering system 700 of FIG. 7 to perform over-advertising of buffering resources is shown. Some time after the port 608 advertises at least 2 credits worth of buffering resources during step 1104 of FIG. 11, the link partner 752 transmits an IB data packet 300 which arrives at the receiver 722 of FIG. 7, in step 1202. The receiver 722 responds by determining the information necessary to create an input queue entry 800, in step 1204. The receiver 722 requests a shared buffer 604 of FIG. 6 from the buffer control logic 606 by storing the input queue entry 800 created during step 1204 into the input queue 732, in step 1206.

The buffer control logic 606 determines whether a shared buffer 604 is available, in step 1208. If a shared buffer 604 is available, then the buffer control logic 606 deasserts control signal 742, thereby allowing the packet 300 data to flow through the inline spill buffer 612 to the allocated shared buffer 604, in step 1232. In parallel to step 1232, the buffer control logic 606 examines the level of free shared buffers 604 in the free pool that was initially created during step 1102.

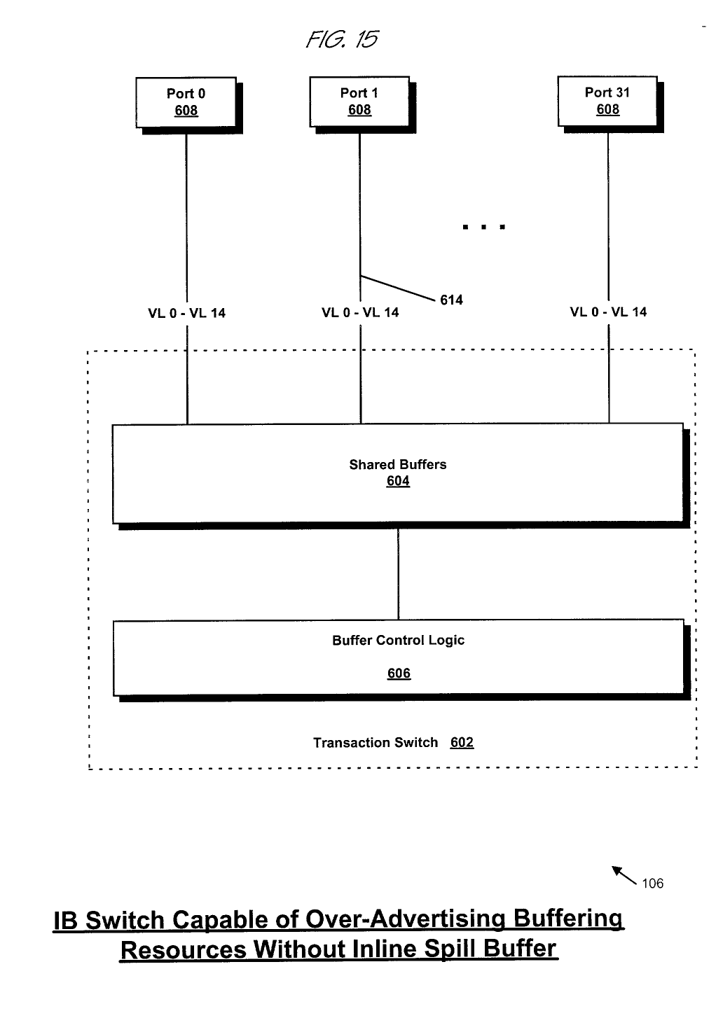

Referring briefly to FIG. 13, a block diagram illustrating free pool ranges 1302-1306 within the shared buffers 604 is shown. The buffer control logic 606 maintains a percentage of shared buffers 604 that are free relative to the total amount of shared buffers 604, i.e., relative to the total amount of shared buffers 604 that are free plus those currently allocated for use. Initially, the percentage of free shared buffers 604 is 100% after the free pool is created during step 1102 of FIG. 11. When all the shared buffers 604 are allocated, the free shared buffers 604 is 0%.

FIG. 11 shows a low free pool range 1306, a middle free pool range 1304 and a high free pool range 1302. The low free pool range 1306 ranges from all shared buffers 604 in use (or 0% free) to a low free mark 1314. The high free pool range 1302 ranges from a high free mark 1312 to all shared buffers 604 free (or 100% free). The middle free pool range 1304 ranges from the low free mark 1314 to the high free mark 1312. Preferably, the low free mark 1314 and the high free mark 1312 are user-configurable. In one embodiment, the marks 1312 and 1314 are predetermined values. The buffer control logic 606 utilizes the ranges 1302-1306 for smoothing out abrupt consumption of shared buffers 604, as will be seen in the remaining description of FIG. 12 below. In one embodiment, the free pool ranges are maintained and monitored by the buffer control logic 606 across all the ports 608 of the switch 106. In another embodiment, the free pool ranges are maintained and monitored by the buffer control logic 606 individually for each of the ports 608 of the switch 106.

Returning to FIG. 12, the buffer control logic 606 determines whether the shared buffer 604 free pool has transitioned to the middle free pool range 1304 as a result of allocating a shared buffer 604 for reception of the packet 300 during step 1232, in step 1234. If the buffer control logic 606 determines the shared buffer 604 free pool has not transitioned to the middle free pool range 1304, the buffer control logic 606 instructs the flow control logic 726 via control signals 744 to continue to advertise at least 2 credits for the VL specified in the packet 300, in step 1236. That is, the port 608 continues to over-advertise the amount of buffering resources available to the link partner 752, advantageously enabling the link partner 752 to transmit packets 300 at essentially full link bandwidth.

If the buffer control logic 606 determines the shared buffer 604 free pool has transitioned to the middle free pool range 1304, the buffer control logic 606 instructs the flow control logic 726 via control signals 744 to advertise only 1 credit for the VL specified in the packet 300, in step 1238.

If the buffer control logic 606 determines during step 1208 that a shared buffer 604 is not available, the buffer control logic 606 asserts control signal 742 to cause the packet 300 from the receiver 722 to begin spilling into the inline spill buffer 612 of FIG. 7 rather than flowing through the inline spill buffer 612, in step 1212. If a shared buffer 604 is not available, the buffer control logic 606 generates a value on control signals 744 to cause the flow control logic 726 to shut down the link partner 752, in step 1212.

In response to control signals 744 generated during step 1212, the flow control logic 726 of FIG. 7 causes the transmitter 724 to shut down the link partner 752 by transmitting to the link partner 752 flow control packets 500 advertising 0 credits for all the VLs 614 configured on the port 608, in step 1214. The system 700 then waits for a shared buffer 604 to become available to receive the packet 300, in step 1216. Meanwhile, the packet 300, and any subsequent packets 300 received at the receiver 722 flow into the inline spill buffer 612 and are stored. As described with respect to FIG. 10, advantageously the inline spill buffer 612 is sized appropriately to be capable of storing all the data the link partner 752 transmits during the shutdown latency time 1014 of FIG. 10, thereby facilitating over-advertising, such as is performed during step 1104 of FIG. 11 and step 1236.

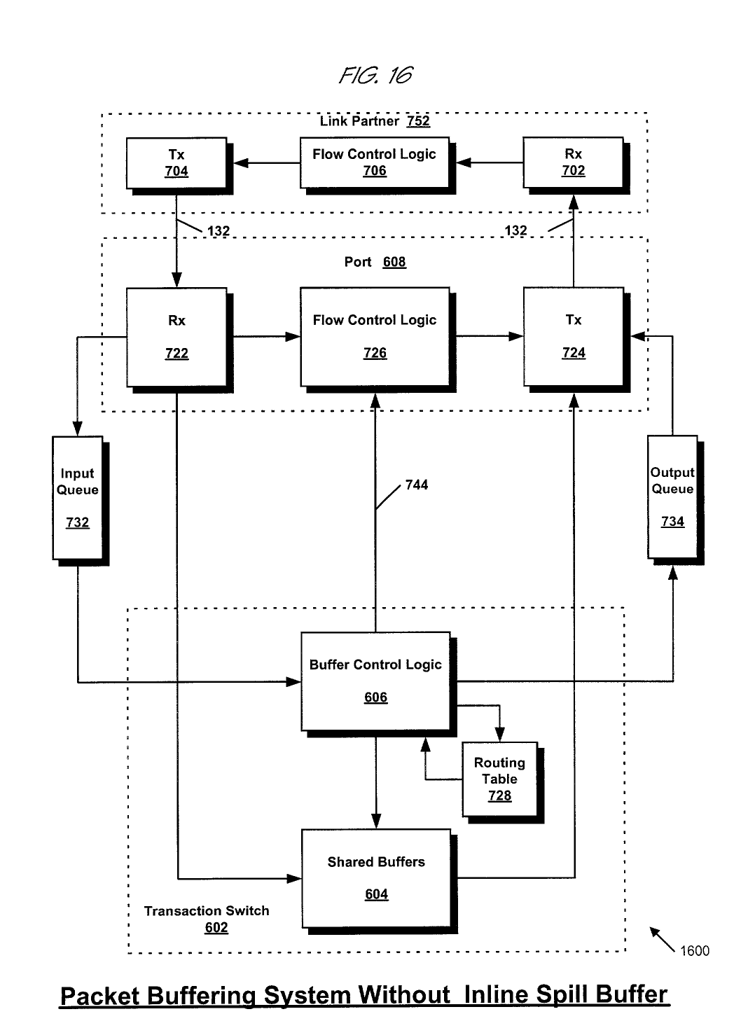

Eventually a packet 300 will be transmitted out one of the ports 608 causing a shared buffer 604 to become free. Operation of the buffering system 700 upon a shared buffer 604 becoming free is described with respect to FIG. 14 below. Once a shared buffer 604 becomes available, the buffer control logic 606 deasserts control signal 742 to cause the inline spill buffer 612 to allow the packet 300 data to drain into the newly available shared buffer 604, in step 1218.

Once the packet 300 has been stored in a shared buffer 604, the buffer control logic 606 uses the DLID 812 of the input queue entry 800 to determine from the routing table 728 the destination port 608 of the packet 300, in step 1242. If necessary, the VL of the packet 300 is updated, in step 1244. For example, if the VL specified when the packet was received into the switch 106 is not supported on the destination port 608, the VL must be updated, in step 1244.

Next, the buffer control logic 606 notifies the destination port 608 of the outgoing packet 300 by creating an output queue entry 900 and placing the entry 900 in the output queue 734 of the destination port, in step 1246. In response to the output queue entry 900, the transmitter 724 fetches the packet 300 data from the buffer 604 chunks specified in the chunk address fields 908-922 and transmits the packet 300 out the port 608, in step 1248. Once the buffer control logic 606 determines the packet 300 has been transmitted out the destination port 608, the buffer control logic 606 frees, i.e., de-allocates, the shared buffer 604 to the free pool, in step 1248.

Referring now to FIG. 14, a flowchart illustrating further operation of the buffering system 700 of FIG. 7 is shown. FIG. 14 illustrates action taken by the system 700 upon freeing of a shared buffer 604, such as during step 1248 of FIG. 12, in step 1402. First, the shared buffer 604 is returned by the buffer control logic 606 to the free pool, in step 1404.

The buffer control logic 606 determines whether returning the buffer 604 to the free pool has caused a transition to the high free pool range 1302 of FIG. 13, in step 1406. If the free pool has transitioned to the high free pool range 1302, the buffer control logic 606 instructs the flow control logic 726 to advertise 2 credits for each VL on the port 608, in step 1412.

If the free pool has not transitioned to the high free pool range 1302, the buffer control logic 606 determines whether returning the buffer 604 to the free pool has caused a transition to the middle free pool range 1304 of FIG. 13, in step 1408. If the free pool has transitioned to the middle free pool range 1104, the buffer control logic 606 instructs the flow control logic 726 to advertise 1 credit for each VL on the port 608, in step 1414.

Referring now to FIG. 15, a block diagram of an IB switch 106 of FIG. 1 according to an alternate embodiment of the present invention is shown. The switch 106 of FIG. 15 is similar to the switch 106 of FIG. 6. However, the switch 106 of FIG. 15 does not have the inline spill buffers 612 of FIG. 6, as shown. Furthermore, the amount of shared buffers 604 is preferably larger, which is possible since the inline spill buffers 612 are not present. In one embodiment, the shared buffers 604 of FIG. 15 comprise approximately 700 KB of SRAM buffering resources.

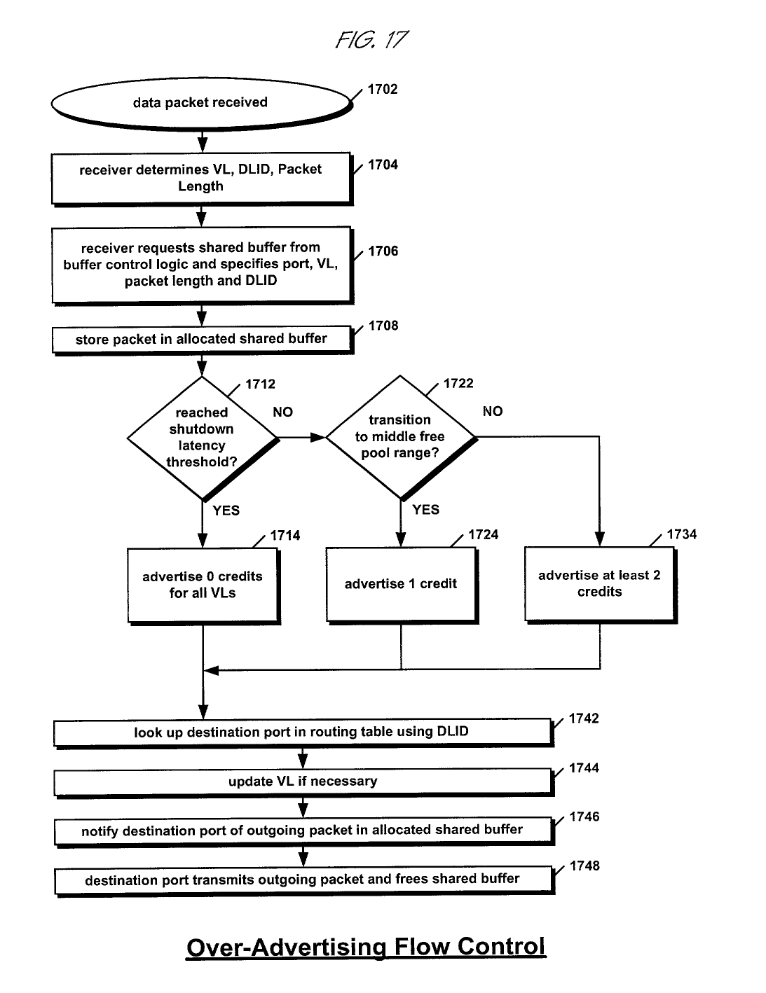

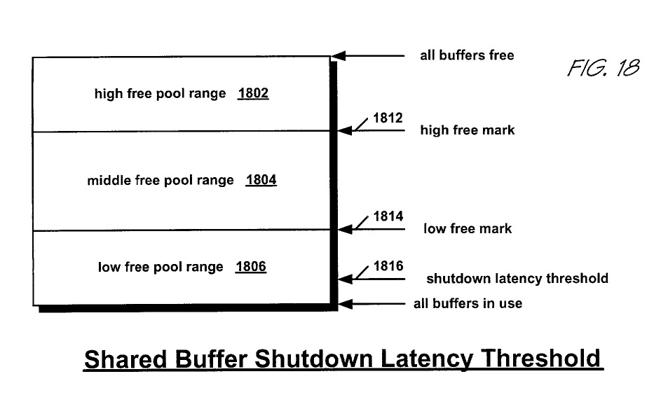

Referring now to FIG. 16, a block diagram of an IB packet buffering system 1600 according to an alternate embodiment of the present invention is shown. The system 1600 of FIG. 16 is employed in the switch 106 of FIG. 15, or similar IB device, not having inline spill buffers 612. The system 1600 of FIG. 16 is similar to the system 700 of FIG. 7. However, the system 1600 of FIG. 16 does not have the inline spill buffers 612 of FIG. 7 as shown. Furthermore, the system 1600 of FIG. 1600 performs over-advertising of buffering resources differently than the system 700 of FIG. 7. In particular, rather than relying on the inline spill buffer 612 to store incoming packets 300 during the shutdown latency, the buffer control logic 606 reserves a portion of shared buffers 604 to store incoming packets 300 during the shutdown latency, as described with respect to FIG. 17.

Referring now to FIG. 17, a flowchart illustrating operation of the buffering system 1600 of FIG. 16 to perform over-advertising of buffering resources is shown. Steps 1702-1706 and 1742-1748 of FIG. 17 are performed similarly to steps 1202-1206 and 1242-1248 of FIG. 12, respectively.

In response to the receiver 722 requesting a shared buffer 604 during step 1706, the buffer control logic 606 allocates a shared buffer 604 and deasserts signal 744 to cause the packet 300 to be stored in the allocated shared buffer 604, in step 1708. That is, the buffer control logic 606 insures that a shared buffer 604 is always available to receive an incoming packet 300 by reserving an amount of shared buffers 604 for storing incoming packets 300 during the shutdown latency, as will be seen below.

After allocating the shared buffer 604 during step 1708, the buffer control logic 606 determines whether the level of free shared buffers 604 has reached a shutdown latency threshold 1816 of FIG. 18, in step 1712.

Referring briefly to FIG. 18, a block diagram illustrating a shutdown latency threshold 1816 is shown. The shutdown latency threshold is the amount of shared buffers 604 needed to store incoming packets 300 during the shutdown latency 1014 determined with respect to FIG. 10. Thus, in an embodiment in which the buffers 604 are shared across all ports 608, the shutdown latency threshold 1816 comprises approximately the number of ports 608 in the switch 106 multiplied by the amount of bytes that may be transferred during the shutdown latency 1014. Hence, for example, in one embodiment, the shutdown latency threshold 1816 is approximately 320 KB. In an embodiment in which the buffers 604 are divided among the ports 608 individually, a free pool is maintained on a per port basis and the shutdown latency threshold 1816 per port 608 is approximately the same amount of bytes as the size of an inline spill buffer 612. Hence, for example, in one embodiment, the shutdown latency threshold 1816 is approximately 10 KB per port.

Returning to FIG. 17, if the buffer control logic 606 determines the level of free pool of shared buffers 604 has reached a shutdown latency threshold 1816 during step 1712, the buffer control logic 606 instructs the flow control logic 726 to advertise zero credits to all VLs 614 configured on the port 608 to shut down the link partner 752, in step 1714.

If the buffer control logic 606 determines the level of free pool of shared buffers 604 has not reached the shutdown latency threshold 1816, the buffer control logic 606 determines whether the level of free pool of shared buffers 604 has transitioned to a middle free pool range 1804, in step 1722. If the level of free pool of shared buffers 604 has transitioned to a middle free pool range 1804, the buffer control logic 606 instructs the flow control logic 726 to advertise 1 credit to the VL 614 specified in the packet 300, in step 1724. Otherwise, the buffer control logic 606 instructs the flow control logic 726 to advertise at least 2 credits to the VL 614 specified in the packet 300, in step 1734. That is, the port 608 continues to over-advertise the amount of buffering resources available to the link partner 752, advantageously enabling the link partner 752 to transmit packets 300 at essentially full link 132 bandwidth.

As may be readily observed from the foregoing disclosure, numerous advantages are realized by the present invention. First, the present invention allows an IB port, or a plurality of IB ports, to support more data VLs than would otherwise be supportable while maintaining essentially full IB link bandwidth through over-advertising of buffering resources. In particular, the present invention enables support of all 15 data VLs as easily as eight, four or two data VLs with essentially the same amount of shared buffering resources. Second, the total amount of memory requirement for an IB device required to maintain essentially link speed is much less than with a conventional approach.

Although the present invention and its objects, features, and advantages have been described in detail, other embodiments are encompassed by the invention. For example, the shared buffers may be configured to allocate a larger amount of buffering resources to particular combinations of VLs and/or ports. For example, a user might configure VL3 on each port to have 8KB more buffering resources allocated to it in order to support a higher quality of service on VL3 for a given application. In addition, the invention is adaptable to various numbers of ports, VLs and shared buffer sizes.

Those skilled in the art should appreciate that they can readily use the disclosed conception and specific embodiments as a basis for designing or modifying other structures for carrying out the same purposes of the present invention without departing from the spirit and scope of the invention as defined by the appended claims:

We claim:

1. A method for buffering packets transmitted to an Infiniband port by an Infiniband device linked to the port, comprising:
providing a portion of a memory for buffering the packets, wherein the portion has a size A;
transmitting flow control credits to advertise to the device buffering resources of a size B, wherein B is greater than A;
determining when the portion is filled with a predetermined amount of the packets; and
transmitting flow control credits to the device to stop transmission of the packets in response to said determining.

2. The method of claim 1, wherein said transmitting flow control credits to advertise to the device buffering resources of a size B comprises transmitting flow control credits to the device for a plurality of Infiniband virtual lanes configured on the port.

3. The method of claim 2, wherein said plurality of Infiniband virtual lanes comprises a number of data virtual lanes from the list consisting of fifteen, eight, four and two.

4. The method of claim 1, wherein said transmitting flow control credits to the device to stop transmission of the packets comprises transmitting flow control credits to the device for a plurality of Infiniband virtual lanes configured on the port.

5. The method of claim 1, further comprising:
providing a second memory for buffering the packets transmitted subsequent to said determining.

6. The method of claim 5, wherein said second memory is coupled between the port and the first memory.

7. The method of claim 5, wherein said determining the portion is filled a predetermined amount comprises determining the portion is approximately full.

8. The method of claim 5, wherein said providing a second memory comprises providing a second memory having a size C.

9. The method of claim 8, wherein said size C is based on an amount of data that may be transmitted to the port during a latency time required to stop transmission of the packets in response to said determining.

10. The method of claim 9, wherein said latency time comprises an approximate amount of time required to perform said transmitting flow control credits to the device to stop transmission of the packets in response to said determining.

11. The method of claim 10, wherein said transmitting flow control credits to the device to stop transmission of the packets in response to said determining comprises transmitting a flow control packet with zero credits for each of a plurality of virtual lanes configured on the port.

12. The method of claim 9, wherein said latency time comprises an approximate amount of time required for the port to transmit a maximum-sized Infiniband data packet to the device.

13. The method of claim 9, wherein said latency time comprises an approximate amount of time required for the device to transmit a maximum-sized Infiniband data packet to the port.

14. The method of claim 9, wherein said latency time comprises an approximate amount of time required for the device to respond to said transmitting flow control credits to the device to stop transmission of the packets in response to said determining.

15. The method of claim 8, wherein said size C is between approximately one Kilobyte and approximately sixteen Kilobytes.

16. The method of claim 1, further comprising:
buffering the packets transmitted by the device subsequent to said determining in a reserved amount of the portion of the memory, wherein said reserved amount is beyond the predetermined amount.

17. The method of claim 16, wherein said reserved amount is between approximately eight Kilobytes and approximately sixteen Kilobytes.

18. The method of claim 16, wherein said reserved amount is based on an amount of data that may be transmitted to the port during a latency time required to stop transmission of the packets in response to said determining.

19. The method of claim 18, wherein said latency time comprises an approximate amount of time required for the port to transmit a flow control packet for each of a plurality of virtual lanes configured on the port.

20. The method of claim 18, wherein said latency time comprises an approximate amount of time required for the port to transmit a maximum-sized Infiniband data packet to the device.

21. The method of claim 18, wherein said latency time comprises an approximate amount of time required for the device to transmit a maximum-sized Infiniband data packet to the port.

22. The method of claim 18, wherein said latency time comprises an approximate amount of time required for the device to respond to said transmitting flow control credits to the device to stop transmission of the packets in response to said determining.

23. The method of claim 1, wherein said determining the portion of the memory is filled a predetermined amount comprises determining an amount of free space in the portion of the memory drops below the predetermined amount.

24. The method of claim 23, wherein said amount of free space is between approximately eight Kilobytes and approximately sixteen Kilobytes.

25. The method of claim 1, wherein said providing a portion of a memory for buffering the packets comprises dynamically allocating the memory from a pool of memory shared among the port and a plurality of other Infiniband ports.

26. The method of claim 1, wherein said providing a portion of a memory for buffering the packets comprises providing the memory in response to user input.

27. The method of claim 1, wherein said providing a portion of a memory for buffering the packets comprises providing the portion of the memory to the port based on a plurality of other ports sharing the memory with the port.

28. The method of claim 1, wherein said transmitting flow control credits to advertise to the device buffering resources of a size B comprises advertising at least two maximum-sized Infiniband packets worth of flow control credits for each of a plurality of virtual lanes configured on the port.

29. The method of claim 1 further comprising:
configuring a plurality of virtual lanes on the port prior to said transmitting flow control credits to advertise to the device buffering resources of a size B.

30. The method of claim 29, wherein a product of said plurality of virtual lanes and a number of bytes comprising two maximum-sized Infiniband packet exceeds size A.

31. A method for controlling flow of packets into a plurality of ports on an Infiniband device, comprising:
providing a memory for buffering the packets, wherein the memory has a size A;
transmitting flow control credits by the plurality of ports to advertise packet buffering resources of a size B, wherein B is greater than A; and
transmitting flow control credits by at least one of the plurality of ports to stop transmission of the packets into the at least one port in response to determining an amount of free space in the memory drops below a predetermined threshold.

32. The method of claim 31, wherein said transmitting flow control credits by the plurality of ports to advertise packet buffering resources of a size B comprises transmitting flow control credits for each of a plurality of virtual lanes configured on each of the plurality of ports.

33. The method of claim 31, wherein said predetermined threshold is based on an amount of data that may be transmitted to the plurality of ports during a latency time required to stop transmission of the packets in response to said determining.

34. The method of claim 31, wherein said predetermined threshold is approximately zero, wherein said method further comprises:
providing a second memory for buffering the packets transmitted subsequent to said determining.

35. A system for buffering packets transmitted by a link partner linked to an Infiniband port, comprising:
a first memory, for buffering the packets from the port;
flow control logic, configured to advertise to the link partner more buffering resources than are available in said first memory for buffering the packets if space is available in said first memory to buffer the packets, and to advertise no buffering resources if no space is available; and
a second memory, coupled between the port and said first memory, for buffering the packets when no buffering resources are available in said first memory.

36. The system of claim 35, wherein said second memory is configured to receive the packets independent of a plurality of virtual lanes specified in the packets.

37. The system of claim 35, wherein a size of said second memory is approximately an amount of data capable of being transmitted to the port during a latency time from when no buffering resources are available in said first memory to when the link partner stops transmitting the packets.

38. The system of claim 35, wherein said flow control logic is configured to advertise to the link partner said buffering resources for a plurality of virtual lanes configured on the port.

39. A system for buffering packets transmitted by a link partner linked to an Infiniband port, comprising:
a memory, having a size;
an inline buffer, coupled between the port and said memory, for selectively buffering the packets if said memory is full; and
flow control logic, configured to advertise to the link partner more flow control credits than space available in said memory, wherein said flow control logic is further configured to advertise to the link partner zero flow control credits when said memory is full.

40. The system of claim 39, wherein said flow control logic is configured to advertise to the link partner more flow control credits than space available in said memory across a plurality of virtual lanes configured on the port.

41. A system for buffering packets transmitted by a link partner linked to an Infiniband port, comprising:
a memory, for buffering the packets from the port;
a buffer controller, for monitoring an amount of free space in said memory; and
flow control logic, configured to advertise to the link partner more buffering resources than are available in said memory for buffering the packets from the port if said buffer controller indicates said amount of free space is above a predetermined threshold.

42. The system of claim 41, wherein said flow control logic is further configured to advertise to the link partner no buffering resources if said buffer controller indicates said amount of free space is below said predetermined threshold.

43. The system of claim 41, wherein said predetermined threshold is approximately an amount of data capable of being transmitted to the port during a latency time from when said buffer controller indicates said amount of free space is below said predetermined threshold to when the link partner stops transmitting the packets.

44. The system of claim 41, wherein said flow control logic is configured to advertise to the link partner said buffering resources for a plurality of virtual lanes configured on the port.

45. The system of claim 44, wherein said memory has a size, wherein said plurality of virtual lanes configured on the port multiplied by a size of at least two maximum-sized Infiniband data packets substantially exceeds said size of said memory.

46. An Infiniband device, comprising:
a plurality of ports, each having a plurality of virtual lanes configured therein;
memory, for buffering packets received by said plurality of ports, said memory having a predetermined size; and
flow control, for advertising an amount of buffering resources comprising at least two Infiniband packets worth of flow control credits for each of said plurality of virtual lanes configured in each of said plurality of ports;
wherein said advertised amount of buffering resources substantially exceeds said predetermined size of said memory.

47. The device of claim 46, wherein said Infiniband device is an Infiniband switch, router or channel adapter.

48. A buffering system in an Infiniband device, comprising:
a port, having a plurality of virtual lanes configured therein;
a memory, for buffering packets received by said port, said memory having a predetermined size; and
flow control, configured to advertise an amount of buffering resources comprising at least two Infiniband packets worth of flow control credits for each of said plurality of virtual lanes configured in said port;
wherein said advertised amount of buffering resources substantially exceeds said predetermined size of said memory.

49. The buffering system of claim 48, wherein said flow control is further configured to advertise zero credits for each of said plurality of virtual lanes configured in said port upon determining less than a predetermined amount of said memory is free to buffer said packets received from said port.
